(19) United States
(12) Patent Application Publication
(10) Pub. No.: US 2017/0300113 A1
(43) Pub. Date: Oct. 19, 2017

(54) ANTI-DIZZINESS METHOD AND APPARATUS FOR USE IN VIRTUAL REALITY SYSTEM

(71) Applicant: Beijing Pico Technology Co., Ltd., Beijing (CN)

(72) Inventor: Jin HAN, Beijing (CN)

(21) Appl. No.: 15/292,978

(22) Filed: Oct. 13, 2016

(30) Foreign Application Priority Data
Apr. 15, 2016 (CN) 201610237727.0

(51) Int. Cl. G06F 3/01; G06T 19/00; G06F 3/0484

(52) U.S. Cl. CPC G06F 3/013; G06F 3/04845; G06T 19/006

(57) ABSTRACT

The present disclosure discloses an anti-dizziness method and apparatus for use in a virtual reality system. The method comprises: deploying a user interface in an arcuate layout manner in an immersive environment; and setting an interface element self-defining interface for a user to adjust content and number of interface elements in the user interface exactly facing to human eyes according to the user's needs. The user interface is deployed in an arcuate layout manner so that the interface element is exactly facing to the user's sight line when the user views any one interface element, and the distance from each interface element to the human eyes is equal, so this may provide a better visual experience to the user so that the user is not apt to fatigue and free of dizziness; furthermore, the user is provided with an interface element self-defining interface, so that the user may adjust content and number of interface elements in the user interface exactly facing to human eyes according to his own needs, and dizziness caused by frequent head turning is avoided.

### CROSS-REFERENCE TO RELATED APPLICATION

This application claims the benefit and priority of Chinese Patent Application No. 201610237727.0 filed Apr. 15, 2016. The entire disclosure of the above application is incorporated herein by reference.

### FIELD OF THE DISCLOSURE

The present disclosure relates to the technical field of virtual reality, and particularly to an anti-dizziness method and apparatus for use in a virtual reality system.

### BACKGROUND OF THE DISCLOSURE

As virtual reality technologies gradually prevail, more and more virtual headset devices gradually arise. However, many experiencers state that upon experiencing virtual reality headset devices, they feel extremely dizzy once they move, which becomes a barrier in the development of virtual reality technologies. At present, the dizziness generated when the user uses the virtual reality system is mainly solved by improving hardware performance, for example, ease dizziness by improving the refresh rate of the screen, reducing system delay or the like. However, the boost of hardware performance still takes time and needs joint efforts. Currently, only the improvement of hardware performance is not sufficient to completely solve the dizziness caused by the virtual reality system to the user.

### SUMMARY OF THE DISCLOSURE

In order to release the dizziness generated when the user uses the virtual reality system, the present disclosure provides an anti-dizziness method and apparatus for use in a virtual reality system.

According to one aspect of the present disclosure, the present disclosure provides an anti-dizziness method for use in a virtual reality system, comprising:

deploying a user interface in an arcuate layout manner in an immersive environment; and

setting an interface element self-defining interface for a user to adjust content and number of interface elements in the user interface exactly facing to human eyes according to the user's needs.

Preferably the deploying the user interface in an arcuate layout manner is specifically:

deploying elements in the user interface on a surface of a spherical or cylindrical space around the user with the user as a center so that each element in the user interface is exactly facing to human eyes.

Preferably the method further comprises: setting an interface adjusting interface for the user to adjust an interface switching speed upon interaction with the virtual reality system according to the user's needs.

Preferably the method further comprises:

setting a color adjusting interface for the user to adjust color saturation and brightness of the user interface in the immersive environment according to the user's needs.

Preferably the method further comprises:

setting a distance adjusting interface for the user to adjust a distance depth between the user interface and the human eyes according to the user's needs.

According to another aspect of the present disclosure, the present disclosure provides an anti-dizziness apparatus for use in a virtual reality system, comprising:

an interface deploying unit configured to deploy a user interface in an arcuate layout manner in an immersive environment; and

an element adjusting unit configured to, by an interface element self-defining interface, adjust content and number of interface elements in the user interface exactly facing to human eyes according to the user's needs.

Preferably the interface deploying unit is specifically configured to deploy elements in the user interface on a surface of a spherical or cylindrical space around the user with the user as a center so that each element in the user interface is exactly facing to human eyes.

Preferably the apparatus further comprises: an interface switching and adjusting unit configured to, by an interface switching speed adjusting interface, adjust an interface switching speed upon interaction with the virtual reality system according to the user's needs.

Preferably the apparatus further comprises: a color adjusting unit configured to, by a color adjusting interface, adjust color saturation and brightness of the user interface in the immersive environment according to the user's needs.

Preferably the apparatus further comprises: a distance adjusting unit configured to, by a distance adjusting interface, adjust a distance depth between the user interface and the human eyes according to the user's needs.

Embodiments of the present disclosure have the following advantageous effects: deploy the user interface in an arcuate layout manner so that the interface element is exactly facing to the user's sight line when the user views any one interface element, and the distance from each interface element to the human eyes is equal, so this may provide a better visual experience to the user so that the user is not apt to fatigue and free of dizziness; provide the user with an interface element self-defining interface, so that the user may adjust content and number of interface elements in the user interface exactly facing to human eyes according to his own needs, and dizziness caused by frequent head turning is avoided. In a further preferred embodiment, the user is provided with interfaces for adjusting the switching speed, color and distance, so that the user may, according to his own practical needs, adjust the interaction manner with the virtual reality system such that the user feels less dizziness upon using the virtual reality system and the user's experience is improved.

### BRIEF DESCRIPTION OF DRAWINGS

FIG. 1 is a flow diagram of an anti-dizziness method for use in a virtual reality system according to an embodiment of the present disclosure;

FIG. 2 is a schematic view of user interfaces arranged in an arcuate layout manner in an anti-dizziness method for use in a virtual reality system according to an embodiment of the present disclosure;

FIG. 3 is a schematic view of adjusting content and number of interface elements in the user interface exactly facing to human eyes in an anti-dizziness method for use in a virtual reality system according to an embodiment of the present disclosure;

FIG. 4 is a schematic view of adjusting a distance depth between the user interface and the human eyes in an anti-dizziness method for use in a virtual reality system according to an embodiment of the present disclosure; and

FIG. 5 is a structural schematic view of an anti-dizziness apparatus for use in a virtual reality system according to an embodiment of the present disclosure.

### DETAILED DESCRIPTION OF PREFERRED EMBODIMENTS

Embodiments of the present disclosure will be described below in further detail in conjunction with figures to make the objectives, technical solutions and advantages of the present disclosure clearer.

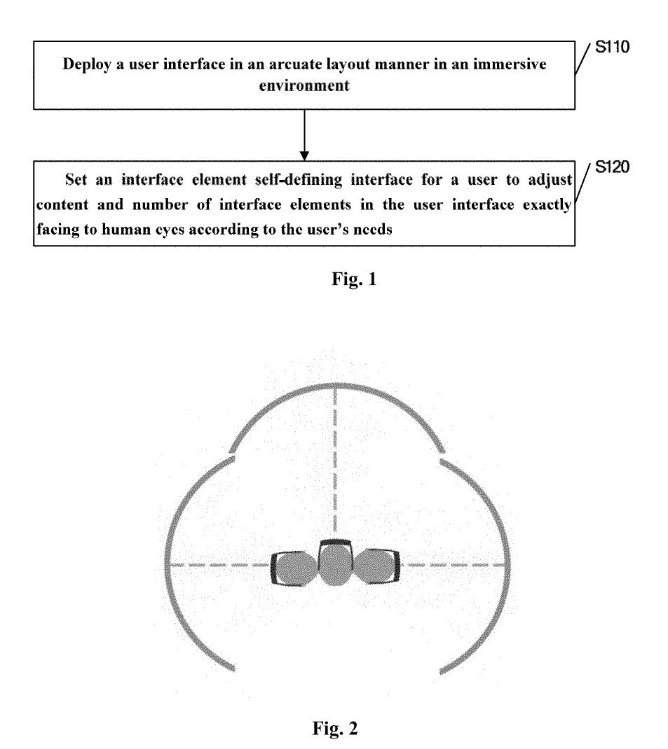

FIG. 1 is a flow diagram of an anti-dizziness method for use in a virtual reality system according to an embodiment of the present disclosure. As shown in FIG. 1, the anti-dizziness method for use in a virtual reality system according to an embodiment of the present disclosure comprises: step S110: deploying a user interface in an arcuate layout manner in an immersive environment.

First, the user sees a graphical user interface in the immersive environment. The user interface in the immersive environment is different from the 2D user interface that can be often seen in reality. The parallel interface as seen by human eyes in the immersive environment generates perspective deformation in a 3D space, i.e., the objects at a near distance seem larger and the objects at a long distance seems smaller than the true sizes. This deformation affects the user's sense of sight. To solve this problem, user interfaces are deployed in an arcuate layout manner when the interfaces are designed for interact. As shown in FIG. 2, each element in such user interface is relatively exactly facing to human eyes so that the user feels very comfortable visually.

Step S120: setting an interface element self-defining interface for a user to adjust content and number of interface elements in the user interface exactly facing to human eyes according to the user's needs.

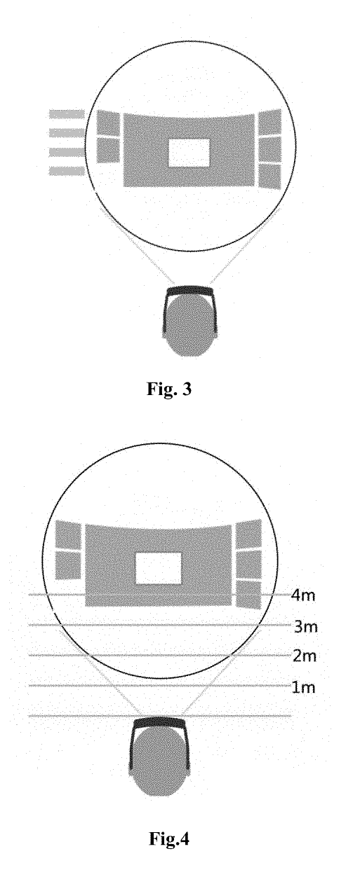

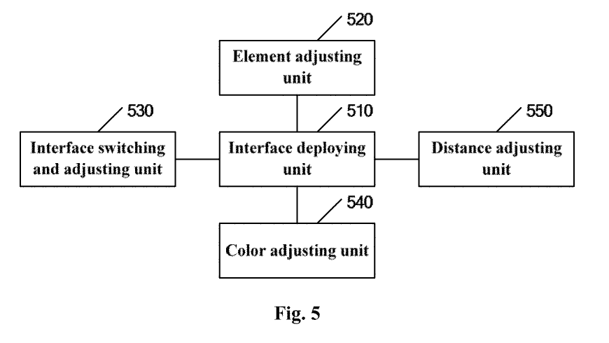

The vision field of human eyes in the immersive environment is limited. Much available space exists in a 360° scope in the immersive environment. If the elements of the user interface are deployed out of the vision field of human eyes, the user must operate these interface elements by turning his head. Particularly, if the objects often operated by the user are deployed too separately, the user must swing his head to and fro in different vision fields, which causes dizziness. If too many interface elements are deployed in the user interface exactly facing to human eyes, it is difficult for the user to find a desired object because the content is too much. Hence, as shown in FIG. 3, the elements in the graphical user interface of the virtual reality system should be kept in a suitable number, not too much or too little, and important and frequently used interface elements are placed in one vision field as many as possible. The frequently used interface elements vary with different users, and different users have different demands for the suitable number of the interface elements placed in one vision field. Hence, the anti-dizziness method for use in a virtual reality system according to an embodiment of the present disclosure provides the interface element self-defining interface, and the user may adjust content and number of interface elements in the user interface exactly facing to human eyes through the interface according to his own needs.

Preferably, the “deploying the user interface in an arcuate layout manner” in step S110 is specifically deploying elements in the user interface on a surface of a spherical or cylindrical space around the user with the user as a center so that each element in the user interface is exactly facing to human eyes. The deployed interface elements may be either planar or arcuate, and these elements are deployed on a surface of a spherical or cylindrical space with the user as the center. As such, when the user views any one interface element, the interface element is exactly facing to the user's sight line; furthermore, the distance from each interface element to the human eyes is equal, so this may provide a better visual experience to the user so that the user is not apt to fatigue and free of dizziness.

In the immersive environment, if actions of an interface such as pop-up and switching are improperly designed in terms of speed and location, e.g., the interface switching speed is too large, pressure will be applied to human eyes, eyes need to remain in a quick browsing state all the time, and long-term view will cause fatigue and dizziness. A suitable switching speed is not necessary the same for different users, that is to say, the same interface switching speed is suitable for some users, but too fast for some users so that dizziness is caused. To meet the needs of different users, in a preferred embodiment of the present disclosure, an interface adjusting interface is provided to enable the user to adjust the interface switching speed upon interaction with the virtual reality system by the interface according to his own actual needs.

In the immersive environment, human eyes become very sensitive to colors. An excessively intense or excessively dim overall color generates stimulus to vision, and the user will feel fatigued in a high-purity too bright or too dark environment for a long time period, and feel dizzy and faint after viewing for a long time period. Hence, in another preferred embodiment of the present disclosure, a color adjusting interface is provided to enable the user to, according to his own needs, adjust color saturation and brightness of the user interface in the immersive environment, so that the overall environment color remains moderate, eyes feel comfortable, and dizziness caused by too bright or too dim environment color can be avoided.

Just like in graphic design, the spacing, size and color of words all affect readability, the spatial distance in the immersive environment also affects the user's visual feeling. If the distance depth between the human eyes and the elements in the user interface is too close, much information fills the human eyes, human eye focusing will become very difficult, and thereby fatigue, dizziness and sickness will be caused. Hence, it is necessary to keep a comfortable vision field distance, and generally a 3 m-4 m vision field distance is the most appropriate. In a further preferred embodiment of the present disclosure, a distance adjusting interface is provided to enable the user to adjust the distance depth between the user interface and the human eyes according to his own needs to a distance felt comfortable by himself.

FIG. 5 is a structural schematic view of an anti-dizziness apparatus for use in a virtual reality system according to an embodiment of the present disclosure. As shown in FIG. 5, the anti-dizziness apparatus for use in a virtual reality system according to an embodiment of the present disclosure comprises an interface deploying unit 510 and an element adjusting unit 520.

In the immersive environment, the interface deploying unit 510 is configured to deploy the user interface in an arcuate layout manner. The element adjusting unit 520 is configured to, by an interface element self-defining interface, adjust content and number of interface elements in the user interface exactly facing to human eyes according to the user's needs, and to keep a proper number of elements in the user interface, and avoid dizziness caused by frequent head turning.

Preferably, the interface deploying unit 510 deploys elements in the user interface on a surface of a spherical or cylindrical space around the user with the user as a center so that each element in the user interface is exactly facing to human eyes, and the distance from each interface element to the human eyes is equal, so this may provide a better visual experience to the user so that the user is not apt to fatigue and free of dizziness.

The anti-dizziness apparatus for use in a virtual reality system according to a preferred embodiment of the present disclosure further comprises an interface switching and adjusting unit 530 configured to, by an interface switching speed adjusting interface, adjust the interface switching speed upon interaction with the virtual reality system according to the user's needs, to avoid pressure caused by a too fast interface switching speed to human eyes and avoid occurrence of fatigue and dizziness.

The anti-dizziness apparatus for use in a virtual reality system according to another preferred embodiment of the present disclosure further comprises a color adjusting unit 540 configured to, by a color adjusting interface, adjust color saturation and brightness of the user interface in the immersive environment according to the user's needs, so that the overall environment color remains moderate, eyes feel comfortable, and dizziness caused by too bright or too dim environment color can be avoided.

The anti-dizziness apparatus for use in a virtual reality system according to a further preferred embodiment of the present disclosure further comprises a distance adjusting unit 550 configured to, by a distance adjusting interface, adjust the distance depth between the user interface and the human eyes according to the user's needs, preferably keep an about 3 m-4 m distance, thereby avoiding eye focusing difficulty caused by excessive information filling into human eyes, and thereby avoiding fatigue, dizziness and sickness.

The anti-dizziness method and apparatus for use in a virtual reality system according to the present disclosure provide the user with interfaces for adjusting interface elements, switching speed, color and distance in a software manner on the basis of current hardware performance, so that the user may, according to his own practical needs, adjust the interaction manner with the virtual reality system such that the user feels less dizziness upon using the virtual reality system and the user's experience is improved.

To conclude, the anti-dizziness method and apparatus for use in a virtual reality system according to the present disclosure, as compared with the prior art, have the following advantageous effects:

1) The anti-dizziness method and apparatus for use in a virtual reality system according to the present disclosure deploys the user interface in an arcuate layout manner so the interface element is exactly facing to the user's sight line when the user views any one interface element, and the distance from each interface element to the human eyes is equal, so this may provide a better visual experience to the user so that the user is not apt to fatigue and free of dizziness.

2) The anti-dizziness method and apparatus for use in a virtual reality system according to the present disclosure provides the user with an interface element self-defining interface, so that the user may adjust content and number of interface elements in the user interface exactly facing to human eyes according to his own needs, and dizziness caused by frequent head turning is avoided.

3) The anti-dizziness method and apparatus for use in a virtual reality system according to the present disclosure provides the user with interfaces for adjusting the switching speed, color and distance, so that the user may, according to his own practical needs, adjust the interaction manner with the virtual reality system such that the user feels less dizziness upon using the virtual reality system and the user's experience is improved.

It should be explained that:

The embodiments of the components of the present disclosure can be implemented as hardware, as a software module executed on one or more processors, or as their combination. A person skilled in the art should understand that, microprocessors or digital signal processors (DSP) can be employed in practice to implement some or all of the functions of some or all of the components according to the embodiments of the present disclosure. The present disclosure can also be implemented as devices or device programs for executing some or all of the method described herein (for example, computer programs and computer program products). Such programs for implementing the present disclosure can be stored in computer readable media, or can be in the form of one or more signals. Such signals can be obtained by being downloaded from interne websites, or be provided by carrier signals, or be provided in any other forms.

The anti-dizziness apparatus for use in a virtual reality system of the present disclosure traditionally comprises a processor and a computer program product or a computer readable medium in the form of memory. The memory can be an electronic memory such as a flash memory, an EEPROM, an EPROM, a hard disk or a ROM and the like. The memory has a storage space for executing the program code of any method step of the above method. For example, the storage space for the program code can comprise each of the program codes for individually implementing the steps of the above method. These program codes can be read out or written in from one or more computer program products to the one or more computer program products. The computer program products comprise program code carriers such as hard disk, compact disk (CD), memory card or floppy disk and the like. Such computer program products are generally portable or fixed storage units. The storage units can be similarly disposed memory segments, storage spaces or the like. The program code can for example be compressed in appropriate forms. Generally, the storage units comprise computer readable codes for executing the method steps according to the present disclosure, that is, codes that can be read by for example processors, and when the codes are executed, the anti-dizziness apparatus for use in a virtual reality system executes each of the steps of the method described above.

It should be noted that, the above embodiments are intended to illustrate the present disclosure, rather than limiting the present disclosure, and a person skilled in the art can design alternative embodiments without departing from the scope of the attached claims. The word “comprise” does not exclude the elements or steps that are not listed in the claims. The present disclosure can be implemented by means of hardware that comprise numbers of different elements and by means of computers that are properly programmed. In claims that list numbers of units of devices, some of these devices can be embodied via the same hardware item.

The description provided herein illustrates many concrete details. However, it can be understood that, the embodiments of the present disclosure can be implemented without the concrete details. In some embodiments, well known methods, structures and techniques are not described in detail, so as not to obscure the understanding of the description. The languages used in the description are chosen mainly for sake of readability and teaching, and are not chosen to interpret or define the subject matter of the present disclosure.

1. An anti-dizziness method for use in a virtual reality system, wherein the method comprises:
deploying a user interface in an arcuate layout manner in an immersive environment; and
setting an interface element self-defining interface for a user to adjust content and number of interface elements in the user interface exactly facing to human eyes according to the user's needs.

2. The anti-dizziness method for use in a virtual reality system according to claim 1, wherein the deploying the user interface in an arcuate layout manner is specifically:
deploying elements in the user interface on a surface of a spherical or cylindrical space around the user with the user as a center so that each element in the user interface is exactly facing to human eyes.

3. The anti-dizziness method for use in a virtual reality system according to claim 2, wherein the method further comprises:
setting an interface adjusting interface for the user to adjust an interface switching speed upon interaction with the virtual reality system according to the user's needs.

4. The anti-dizziness method for use in a virtual reality system according to claim 2, wherein the method further comprises:
setting a color adjusting interface for the user to adjust color saturation and brightness of the user interface in the immersive environment according to the user's needs.

5. The anti-dizziness method for use in a virtual reality system according to claim 2, wherein the method further comprises:
setting a distance adjusting interface for the user to adjust a distance depth between the user interface and the human eyes according to the user's needs.

6. An anti-dizziness apparatus for use in a virtual reality system, wherein the apparatus comprises:
an interface deploying unit configured to deploy a user interface in an arcuate layout manner in an immersive environment; and
an element adjusting unit configured to, by an interface element self-defining interface, adjust content and number of interface elements in the user interface exactly facing to human eyes according to the user's needs.

7. The anti-dizziness apparatus for use in a virtual reality system according to claim 6, wherein
the interface deploying unit is specifically configured to deploy elements in the user interface on a surface of a spherical or cylindrical space around the user with the user as a center so that each element in the user interface is exactly facing to human eyes.

8. The anti-dizziness apparatus for use in a virtual reality system according to claim 7, wherein the apparatus further comprises:
an interface switching and adjusting unit configured to, by an interface switching speed adjusting interface, adjust an interface switching speed upon interaction with the virtual reality system according to the user's needs.

9. The anti-dizziness apparatus for use in a virtual reality system according to claim 7, wherein the apparatus further comprises:
a color adjusting unit configured to, by a color adjusting interface, adjust color saturation and brightness of the user interface, in the immersive environment according to the user's needs.

10. The anti-dizziness apparatus for use in a virtual reality system according to claim 7, wherein the apparatus further comprises:
a distance adjusting unit configured to, by a distance adjusting interface, adjust a distance depth between the user interface and the human eyes according to the user's needs.
